(19) United States
(12) Patent Application Publication
(10) Pub. No.: US 2008/0054007 A1
(43) Pub. Date: Mar. 6, 2008

(54) SYSTEM AND METHOD FOR DISTRIBUTING MEDICATION AND MONITORING MEDICATION PROTOCOL COMPLIANCE

(76) Inventor: Jack Mador, Carmichael, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 11/829,786

(22) Filed: Jul. 27, 2007

Related U.S. Application Data
(60) Provisional application No. 60/834,036, filed on Jul. 27, 2006.

(51) Int. Cl. G07F 11/40; G08B 21/24

(52) U.S. Cl. 221/1; 221/2; 340/657; 340/664

(57) ABSTRACT

A system and method of distributing supplements and medicines while monitoring compliance with a medicine protocol describing a schedule of when the individual doses are to taken. By way of example, a pill card is adapted with frangible compartments for retaining supplements and medicines. Sensors coupled to the frangible compartments detect access to the retained pills. A controller monitors access to the pills and communicates access or schedule issues within a local monitoring device and/or external systems or parties. In one embodiment, the seal attached on the exterior of each pill compartment incorporates a frangible conductor that is broken upon pressing the pills through the membrane, wherein access is thus sensed. Depending on application, feedback (e.g., reminders, compliance alerts, and the like) are provided by the pill card, local monitoring device, or external means in response to data generated by the pill card.

### CROSS-REFERENCE TO RELATED APPLICATIONS

This application claims priority from U.S. provisional application Ser. No. 60/834,036, filed on Jul. 27, 2006, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to medication management and tracking, and more particularly to a system and method for monitoring and assuring compliance with a schedule of medicine and/or supplement administration.

2. Description of Related Art

In recent years increasing attention is being directed to the role of medication management and patient compliance in the health care field. The optimum regimen of medications and supplements is of no value to the patient who is not taking them, or who is not taking them in a sufficiently timely manner. Studies have shown that patient compliance is alarmingly lacking in many instances; for example, one study showed that about half of all prescriptions were taken incorrectly, with problems arising in numerous areas, both for those responsible for taking their own medications and for institutional medicinal compliance.

In order to mitigate these problems, a number of pill reminder systems have been devised that generate periodic reminders when the medication is to be taken. However, these systems require the user to load the system daily and can be difficult to program. Perhaps more problematic is that an individual may not hear the alert, may ignore it, or may turn off the alert without taking a medication dose for that time period.

One proposal involves incorporating an ingestible RFID device into each pill that is monitored by a RFID reader which senses that the pill, and thus, the RFID, has been dissolved. Shortcomings to this system are readily apparent, such as creating ingestible electronic devices, cost factors, tracking multiple pills, and many other problems.

Therefore, a system and method are needed for a low-cost combination of pill repository and tracking system that can receive pharmacy dosaging time and other instructions, remind the user, track compliance, and optionally communicate to the user and to other parties when a lack of compliance arises, so as to assure timely adherence to a dosing schedule. The medication system of the present invention fulfills those needs and others while overcoming drawbacks of prior systems.

### BRIEF SUMMARY OF THE INVENTION

An apparatus, system, and method are described for monitoring medication utilization. A pill card apparatus is configured with a plurality of frangible compartments. Each pill compartment on the card is configured for retaining an individual dose of medications and/or supplements. When the user accesses the medication, this is sensed by a means for sensing the frangible access to any of the plurality of frangible compartments. Information about the frangible access is communicated wirelessly to an external receiver within a device or system which may be located either nearby or remotely. Information can be communicated to nearby systems; for example, to a user interface or to a telemedicine control system. Alternatively or additionally, information can be communicated from the pill card to remotely located systems, such as for notifying family and/or medical personnel and so forth, either through direct communication or relayed through an intermediate device.

In one embodiment of the present invention, a blister card of medications is prepared by a pharmacy and includes several compartments to organize and schedule the pills to be taken by a patient. Dosage and instructions are encoded at the pharmacy and communicated through a “tag” on the card or directly to the home monitoring device. The home monitoring device or reader communicates instructions and warnings to the patient and receives pill card/frangible bursting information that the device records with time information. Information about which pills have been used and which ones still remain is communicated to the home monitoring device. The reader is able to recite cautions and warnings about the particular drugs being used, and an inventory can be controlled automatically to help audit compliance and even order refills.

In another embodiment of the present invention, data regarding the frangible bursting time and sequence may be combined with monitoring data from other peripherals tied to the home monitoring device, such as physiological monitors. This data is transmitted by and through various means to a data collection, correlation, and/or analysis service agency, and the raw or refined data is then transmitted to other entities, such as doctors, hospitals, nurses, other authorized family members or third parties, or any combination thereof.

An aspect of the invention is an apparatus for monitoring medication utilization, comprising: a plurality of frangible compartments, each compartment configured for retaining an individual dose of medications and/or supplements; means for sensing when frangible access is made to any of the plurality of frangible compartments; and means for wirelessly communicating the frangible access to an external receiver adapted for medication management.

In one mode of this aspect, the means for sensing frangible access comprises at least one conductive element coupled to a given frangible compartment and configured to change conductivity in response to accessing a dose from the given frangible compartment. In another mode of this aspect, the means for sensing frangible access comprises at least one conductive pathway whose conductivity is changed in response to accessing a dose from the given frangible compartment.

In another mode of this aspect, the means for wirelessly communicating comprises a radio-frequency transmission device configured for communicating information about frangible access being made to the medications and/or supplements contained in the frangible compartments.

Another aspect of the invention is an apparatus for monitoring medication utilization, comprising: a plurality of frangible compartments, each compartment configured for retaining an individual dose of medications or supplements; a sensing element coupled to each of the plurality of frangible compartments and configured for sensing when frangible access is made to any of the plurality of frangible compartments; and a transmitter element configured for wirelessly communicating the frangible access to an external receiver adapted for medication management.

In one mode of this aspect, the sensing element comprises at least one conductive pathway whose conductivity is changed in response to accessing a dose from the given frangible compartment. In another embodiment of this mode, the conductive pathway is severed in response to accessing a dose from the given frangible compartment. In another embodiment, the conductive pathway is disposed upon a frangible membrane which seals each compartment to form a frangible compartment.

A still further aspect of the invention is a method of tracking medication administration, comprising: retaining a plurality of individual doses within frangible compartments for access by a user; changing an electrical circuit configuration in response to breaking the frangible seal on any of the individual doses; detecting access to a dose in response to receiving the change in electrical circuit configuration; communicating to a remote unit in response to the detected access; wherein the communicating is over a wireless communication medium; and wherein the remote unit is configured for tracking dose accesses, or for communicating to an external device over a wired or wireless communication medium, or a combination of tracking dose accesses and external device communication.

Yet another aspect of the invention is a system for controlling medications taken by a patient, comprising: a pill card with individual compartments filled with medications for a patient, and including sensors to detect which medications have been dispensed, and including devices to report a pill payload status; a number of specialized medical device peripherals arrayed to collect physiological data about the patient in periodic tests; a home monitor for reading the pill payload status from the pill card, and for collecting data obtained by the number of specialized medical device peripherals; and a data collection, correlation, and analysis process able to receive data collected from the home monitor, and for providing an analysis of the effectiveness of the medications as judged by the patient's adherence to dosage schedules and the responses observable in the physiological data.

In other modes of this aspect, the pill card includes medicines in injectible form and can comprise a single dose; or the pill card includes medicines in pill form, and uses blister packaging wherein the rupturing of a back covering causes the sensors to operate.

Another mode of this aspect further comprises a packaging robot for location at a pharmacy that can assemble pharmaceuticals into the pill card, and that further records which pharmaceuticals have been loaded into which compartments of particular pill cards and their associations with particular patients.

Other modes of this aspect further comprise a card identification device to enable the recording of which pharmaceuticals have been loaded into which compartments of particular pill cards and their associations with particular patients; a speaker connected to the home monitor for announcing dosage schedules and cautions to the patient; or a display connected to the home monitor for showing dosage schedules and cautions to the patient.

Another aspect of the invention is a method for controlling doses of medicines for patients at home, comprising: packaging medicines into a container that is able to automatically report when a patient actually consumes a particular dose; monitoring the container for evidence the patient has taken a dose of the medicines; collecting physiological data from the patient during the time frame the patient is taking doses of the medicines from the container; correlating and analyzing the apparent physiological effects on the patient that the medicines are having given the dosage schedules that are actually being observed; and adjusting dosage schedules and medicines to arrive at target values for physiological data as determined by a doctor.

Other modes of this aspect further comprise announcing to said patient certain doses are due to be taken or announcing to the patient cautions associated with taking certain doses due to be taken.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is an illustrative embodiment of the system according to the present invention.

FIG. 2 is an illustrative embodiment of a medication card and local monitoring device according to the present invention.

FIG. 3 is an example of a conductive sensing element in a medication card.

FIG. 4 is an illustrative embodiment of a disposable medication card with a reusable controller section.

FIG. 5 is an illustrative embodiment of a system according to the present invention.

FIG. 6 is a flowchart of a monitoring method according to the present invention.

FIG. 7 is an illustrative embodiment of the system according to the present invention.

FIG. 8 is an embodiment of a medication card according to the present invention.

### DETAILED DESCRIPTION OF THE INVENTION

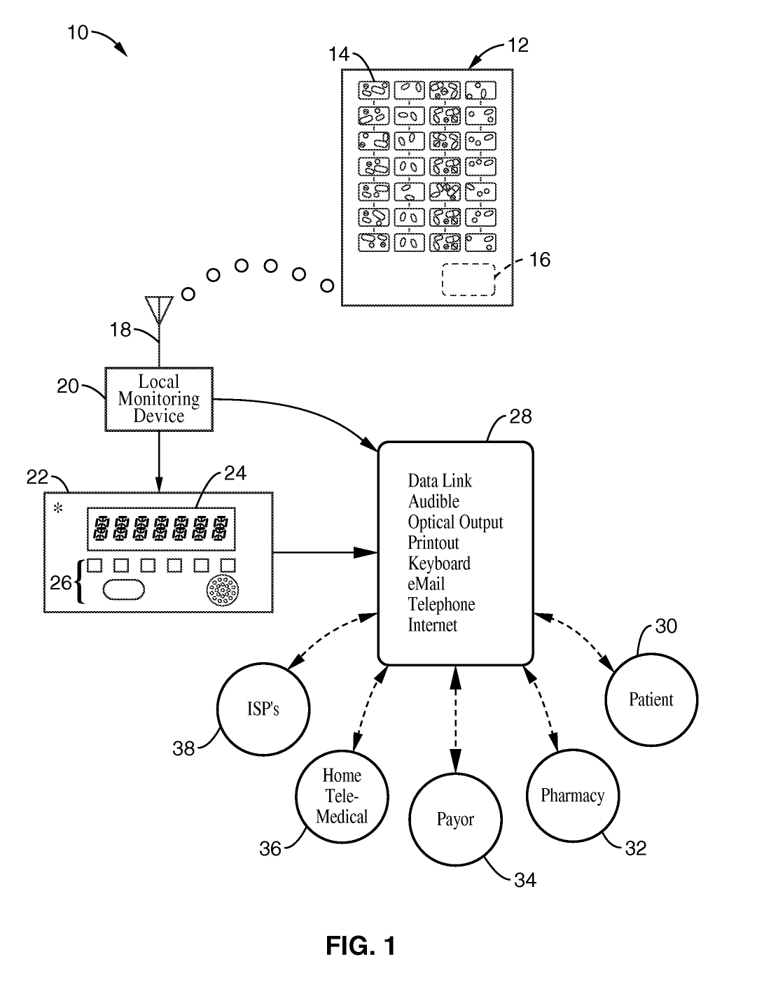

Referring more specifically to the drawings, for illustrative purposes the present invention is embodied in the system and apparatus generally shown in FIG. 1 through FIG. 8. It will be appreciated that the apparatus may vary as to configuration and as to details of the parts, and that the method may vary as to the specific steps and sequence, without departing from the basic concepts as disclosed herein.

The present invention aids users, family, caregivers, pharmacies, medical personnel, and others to assure compliance with medicine protocols, which are also referred to generally as dosing schedules or by other terms of art. It should be appreciated that each of the separate doses contained by the system can comprise medications, supplements, or any desired combination of these and similar comestibles. Although the term medication will be generally used herein, it should be appreciated that the compartments can be loaded with both prescription and non-prescription items, which can comprise medications (e.g., prescription medicines, over the counter medicines or analgesics, and the like), supplements (e.g., vitamins, minerals, herbs, and the like), and so forth.

A repository of medicine and/or supplements is described, having a plurality of sealed and/or frangible compartments, also referred to as cells, for retaining pills or other forms of medicine or supplements. In a preferred embodiment, the compartments are contained on a card (pill card), or other backing, such as in a blister-packaging arrangement. It will be noted that pills include supplements and medicines in the form of solids, gels, capsules, and so forth. The term “pills” will be generally utilized herein, although it should be appreciated that the invention may be practiced with supplements and medications supplied in alternative forms, such as powders, crystals, microencapsulated, liquids, pastes, creams, and so forth.

The pill compartments are coupled to a means for detecting access to the pill compartments. It should be appreciated that any form of sensing means may be utilized, such as detecting frangibility, puncture, change in air pressure, and so forth. By way of example, one inexpensive circuit for sensing compartment access utilizes sensing a change of conductivity along one or more conductive pathways within an area that is broken in response to accessing the compartment.

FIG. 1 illustrates an example embodiment 10 of a medication management system having a medication card 12 with compartments 14 and a communication means 16, such as a transmitter. Transmission from medication card 12 is shown adapted for reception by a local monitoring device 20, such as through antenna 18.

In one implementation, local monitoring device 20 is adapted with a user interface 22, such as one configured for generating outputs to a user and collecting user inputs. Output is shown comprising a display 24, such as text and/or graphical, as well as audio annunciation, although any form and/or combination of audio and optical displays can be utilized. User input is exemplified as buttons 26, although any form of buttons, keypads, selectors, bio-metric identifiers, and other devices adapted for registering inputs can be similarly provided for registering user input.

The local monitoring unit can be adapted to directly perform a number of medicine management functions, and/or adapted to communicate information to other electronic units which execute these and/or higher levels of medicine management. Representing any desired number of such interfaces is interface 28 which is exemplified as representing data links, audible output, optical output, printouts, keyboards and selectors, emails, telephonic communication, Internet or network communication, and so forth. Interface 28 is shown adapted for communication with patient 30, pharmacy 32, payor 34, home telemedicine 36, and ISPs 38. It will be appreciated that interfacing with these parties can provide for more control in the filling process as well as in the monitoring of use of the medications and supplements. For example, in the case of payor, it will be appreciated that an outside party (a party other than the user) may be paying for the medication, such as in association with an insurance plan, wherein checking on compliance and use can be important, in particular with regard to those insurance policies involved with total health responsibility.

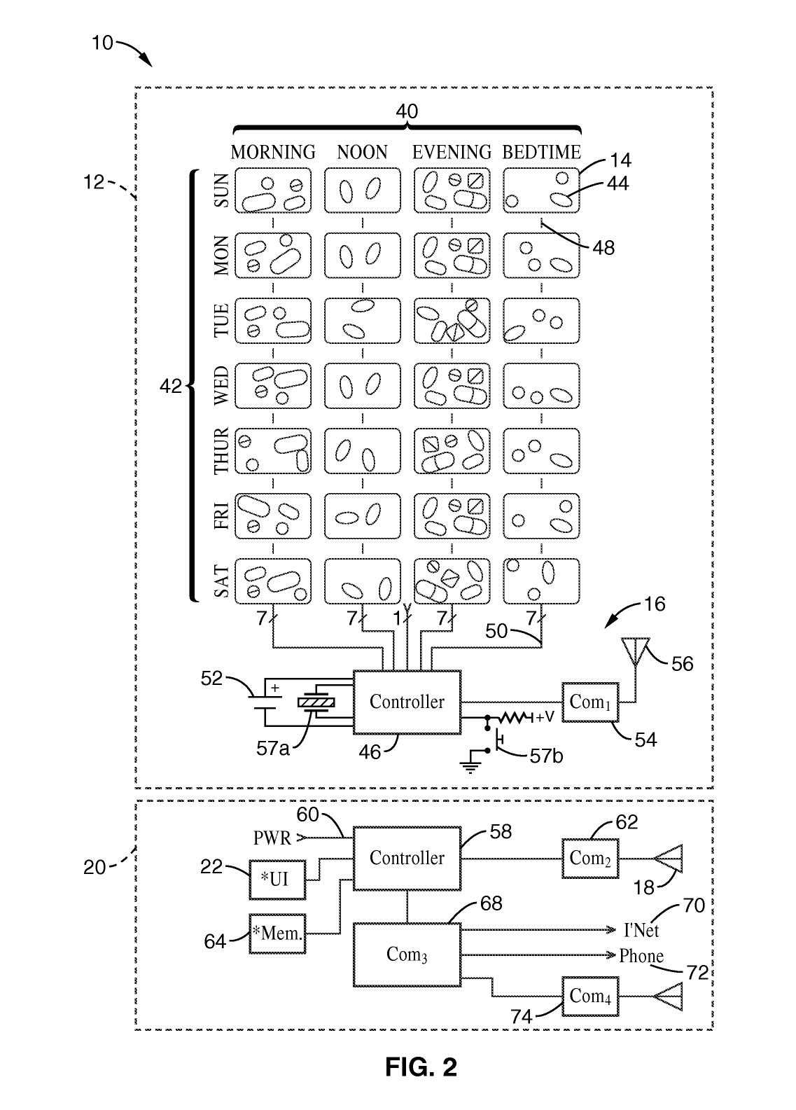

FIG. 2 illustrates an embodiment of the medication card 12 and local monitoring device 20 with additional details depicted. The number of compartments (cells) on the pill card is determined by the desired number of time periods 40 into which a day is to be divided and the number of days 42 that are to be spanned within a cycle of medication. The card shown incorporates 28 compartments providing four columns of compartments addressing four pill taking intervals (e.g., morning, noon, evening and bedtime) and with seven rows of compartments spanning a week (e.g., Sunday through Saturday). It will be appreciated that pill cards can be adapted, spanning any desired number of days and accommodating any desired number of dosing intervals.

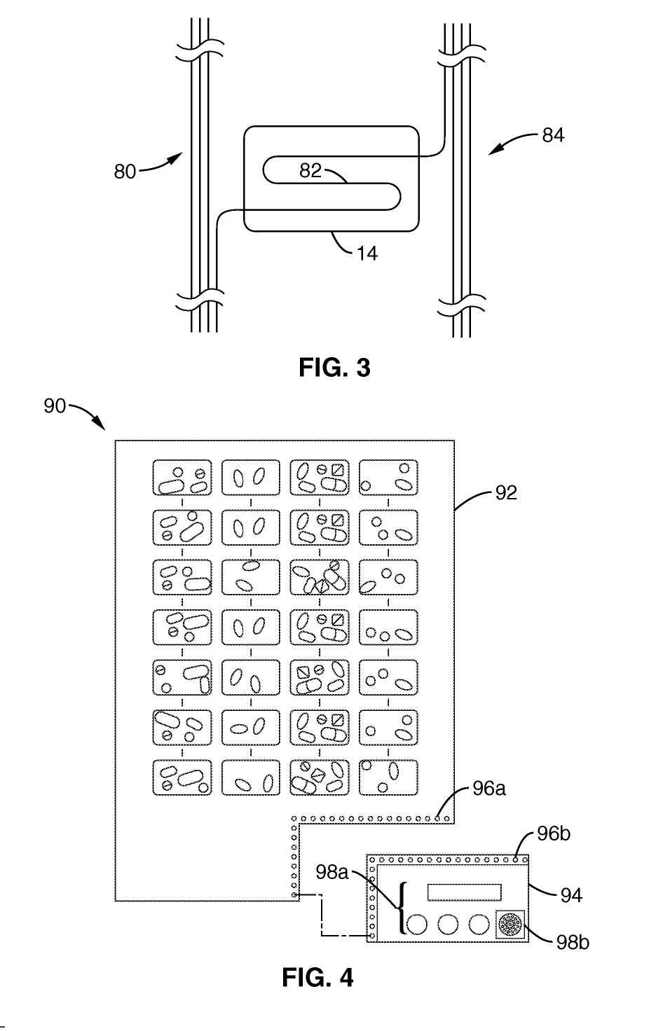

Reporting of pill access is performed on a per cell basis by the pill card. In the implementation shown, a single controller 46 is adapted to monitor access to a plurality of cells utilizing a plurality of interconnections 48. Any desired form of sensing may be utilized to detect when one of the cells are accessed, such as in response to breaking through a sealing membrane to extract the pills therefrom. In the example shown, conductive pathways on the sealing membrane are directed from the controller through each of the cells to a common signal. When the pills are pressed through the sealing membrane the conductive pathway is broken, which can be sensed by the controller. This is discussed in greater detail in relation to FIG. 3.

A compartment 14 is shown configured to provide for the retention of a plurality of pills 44, although some compartments of a pill card may be unused or in other cases retain only a single pill. According to the present invention, the pill card can be implemented in either a disposable form, or a reusable form. In a disposable form the cells of the pill card along with the controller are disposed of after use. A reusable form can be implemented in which after the pills are consumed, the tray can be refilled and a new membrane applied to the pill card (i.e., adhesive sealed, heat-sealed, and so forth). In another implementation, a hybrid approach is described in which the control circuit and battery can be removed from one pill card for attachment to another pill card; this embodiment is later discussed in more detail. These implementations are subject to modification and combination by one of ordinary skill in the art without departing from the teachings of the present invention.

By way of example, the pill card can be implemented with a cardboard base coupled to a transparent blister member containing compartments for retaining medication. A sealing membrane containing means for sensing access is then disposed over the openings of the blister member. The sealing membrane preferably comprises a flexible frangible material that is an electrical insulator or a material that is joined to one or more layers of conductive pathway layers through an insulating layer.

Controller 46 may comprise any desired circuitry adapted for sensing the state of the cells. For example, a very inexpensive microcontroller can be utilized that has sufficient on-board resources, such as I/O lines, timebase, program memory, registers, and data memory. It should be appreciated that a controller can be implemented with microprocessors, a variety of circuits containing processor cores, the use of gate arrays, discrete circuits, and so forth, without departing from the present invention.

In one embodiment, controller 46 stores information within memory or registers about the state of each cell, for example as being “accessed” (taken) or “not-accessed” (not taken). Optionally, controller 46 can store a timestamp relating the absolute time of dose access, or a relative access time, such as in response to wake-up intervals of a microcontroller operating in a low power mode.

Power to the controller is shown supplied to controller 46 from a battery 52 (i.e., discrete cell or integrated into the pill card itself, such as according to polymeric layer deposition), although other sources of power may be utilized such as solar power, piezo-electric power, inductively coupled power, and any other convenient power source or combination of sources.

A communication circuit 54 is shown coupled to the controller and configured to communicate information relating to accesses of the pill compartments. Preferably, the communication circuit provides wireless communication and is shown as having antenna 56. Communication of information to a local monitoring device allows an inexpensive, preferably disposable, pill card to be produced as the bulk of processing and feature functionality is performed in the local monitoring device or other devices with which it communicates. The wireless communication circuit should provide sufficient range for the local monitoring device to maintain updated information about what medicine has been taken and which has not. For example in a typical household situation, a range of about seventy-five feet (75 ft.) would generally prove an acceptable range. In a patient care facility within a single room, the range may only need to be on the order of ten to twenty feet. If the user travels with their pill card, then the local monitoring device would preferably travel with them, such as in a separate monitoring device, or integrated within an existing device, such as a local communication circuit and programming residing on a personal digital assistant (PDA), telephone, watch, or circuit-enabled fobs and jewelry, or similar devices. It will be noted that properly supporting differing application areas can require different range levels.

Transmissions from the pill card can be either synchronous or asynchronous, or a combination thereof. Asynchronous communication can be generated, for example, in response to access of a pill compartment, such as wherein the access triggers a transmission. The transmission from the pill card can either report only the detected access, or it may more preferably report the access as well as the status of all cells, or selected other cells. Synchronous communication can be performed in response to receiving a signal, and/or sufficient received power (i.e., coupled inductive power) to trigger the circuits on the pill card to respond. This query-response pattern is indicative of standards such as used with regard to passive RFID. A robust embodiment can be implemented which generates a transmission at the time of access, and then generates transmissions synchronized temporally (i.e., based on an internal clock) or in response to a query transmission from a remote device. In this way, proper pill status is maintained, even if one or more transmissions are lost, such as those triggered in response to pill access.

Communication can be performed according to any convenient mechanism, such as WiFi®, 900 MHz technology, Bluetooth®, RFID, inductive coupling, electric field modulation, magnetic sensing, cable connectivity, power-line interfaces, satellite connectivity, wearable electronic interfaces, upcoming standards and the like. The inexpensive radio frequency identification (RFID) format can be utilized to support short range applications; however, this format would provide a limited range of about ten feet. Preferred embodiments, therefore, utilize transmission types which can provide a sufficient range, such as up to seventy-five or one hundred feet, and so forth. Numerous transmission formats exist for this range. As the data transmitted is very limited in depth (i.e., on the order of from 1 byte to 100 bytes of data), any convenient data formatting can be utilized, such as on-off keying (OOK), phase-shift keying (PSK), and others, as will be known to one of ordinary skill in the art.

Controller 46 may optionally support limited I/O, such as a simple display (i.e., LCD, or electronic-ink, and so forth) and/or audio annunciation 57a, as well as input button 57b, for example to annunciate alerts to take medications and acknowledge the alerts. It should, however, be appreciated that it is preferred that I/O and alerts be generated from the local monitoring device, or from external devices to which the local monitoring device communicates, therein maintaining the simplicity of the pill card.

Operations within local monitoring device 20 shown in FIG. 2 are shown as subject to the control of controller circuit 58 receiving any desired form of power 60 (e.g., battery, solar, AC adapter, and the like). It will be noted that, although a microprocessor is a preferred circuit, other circuit types can be utilized. The processing power of controller 58 would typically exceed that of controller 46, in view of both the additional operations performed and cost factors constraints which are not as stringent, since local monitoring device 20 is not preferably disposable.

Communication circuit 62 is configured for receiving data from communication circuit 54, and optionally transmitting control information to communication circuit 54.

An optional user interface 22 is shown on the local monitoring device, such as depicted in FIG. 1. According to one embodiment, management and control functions of the system are implemented fully or partially by the local monitoring device 22, wherein user input and output are necessary. This embodiment can, for example, comprise a local unmonitored system (no external systems monitor the medicine protocol). In one such implementation, the user interface can generate audible alerts to remind the user about taking a given dose of pills, or to alert parties about a medicine schedule compliance issue. From the display, information can be output about the schedule, about compliance to the schedule, information about the times at which the respective doses were accessed, as well as information about the card itself such as when filled and by what party, with optional contact information. In addition, local monitoring device 22 preferably supports the generation of communications to external units in response to receipt of data from the pill card, and/or in response to parameters set for alert conditions (e.g., more than one cell accessed, pill access time (late or early) exceeding a selected threshold, and so forth).

However, in a monitored system embodiment, the local monitoring device can be implemented as a form of relay station to direct information to another system, for example, to a patient monitoring system for a patient care institution. In such an instance as the above, it may not be desirable to provide patient control of the system through the local monitoring device.

An optional memory circuit 64 is shown for retaining extended statistics about medication access, medication protocols to be followed, and so forth.

To support a hierarchical medication management paradigm, local monitoring device 20 can be optionally adapted with additional communication facilities. By way of example, and not limitation, communication circuit 68 is shown for supporting one or a number of communication protocols, such as internet connectivity 70, telephone connectivity 72, and wireless connectivity through another communication device 74, such as supporting wireless telephone connectivity.

Returning now to consider implementation of the medication card itself, which is the most cost-sensitive component, a mechanism is described for sensing user access to the medication through frangible pill compartments or cells.

FIG. 3 depicts an example of the conductive sensing, as described in FIG. 2, with a first group of conductive traces 80 routing up one side of the cells and being sequentially routed 82 across the surface of the membrane covering a cell 14 to a second group of conductive traces 84 that continue to be routed up the opposing side of the cells. It will be noted that trace 82 is routed circuitously across the membrane, wherein a rupture of any portion of the membrane in cell area 14 will break trace 82 and may thus be detected. The controller can sense the state of each line by using any convenient technique, such as by using a pulled-up common sense line then sequentially pulling each of the lines (i.e., 28 lines would be utilized for FIG. 2) to ground, then switching the mode of that microcontroller port to input and checking the input state. In this case detecting a logic 1 level by the controller indicates the cell is still intact, while detecting a logic 0 level indicates the cell has been accessed. Although this implementation utilizes one sense line for each cell it has the advantage of being routable on a single layer of the membrane, such as in a single printing step, without the need of deposited resistors or insulating layers. The membrane covering the cells can comprise an electrical insulator, such as Mylar, upon which conductors are disposed, such as through a printing process using conductive inks. Other layers may be included as desired to provide any desired level of protection. For example, a full span metal layer may be included on the opposing side of the Mylar, or otherwise insulated from the trace layer. It will be appreciated that the routing paths and sensor elements can be provided in a number of alternative ways.

It should be readily appreciated that a number of different techniques may be utilized for detecting accesses to the cells on the pill card. By way of example and not limitation, other methods include: using resistive (or capacitive) ladder elements to reduce the number of signal lines needed for sensing, utilizing keyboard style row-column sensing, embedding a piezo layer that generates a voltage in response to membrane displacement pressure, and combinations thereof, while additional mechanisms will be known to one of ordinary skill in the art based on the teachings herein.

Alternatively, each cell can be individually coupled to a communication device to report access to any cell or, alternatively, to any group of cells. It should also be appreciated that the cells can be subdivided to any desired granularity for control by a control circuit.

FIG. 4 illustrates an example embodiment 90 in which the pill card 92 is disposable while being configured for attachment of a reusable controller section 94 via electrical connections 96b configured for mating with electrode areas 96a, for instance, using a friction fit of the card edge within the connector on controller section 94. It should be appreciated that this embodiment can communicate with local or external receiving devices which are not shown in this embodiment in a similar manner as that described for other embodiments.

With a reusable controller portion of the pill card, it becomes more favorably cost-effective to provide simple display and control functions (though still optional), such as depicted by display and buttons 98a, while an audio transducer is shown 98b for generating audible alerts. It should also be appreciated that a more robust power source can be utilized, such as a replaceable coin cell battery, solar cell, or the like.

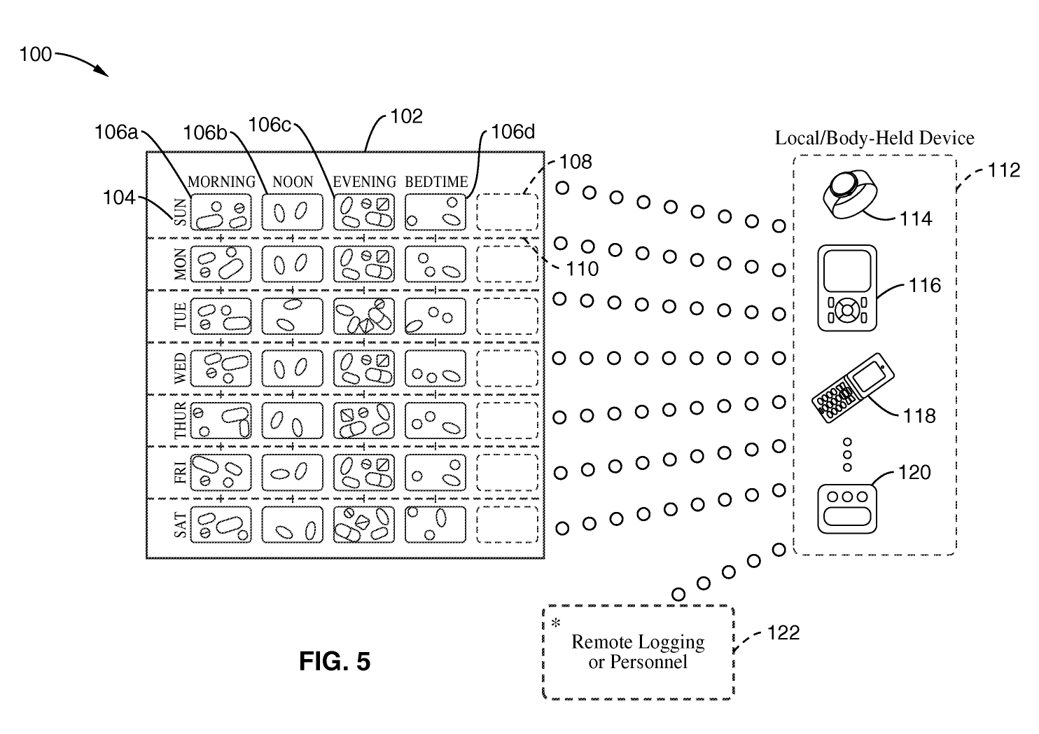

FIG. 5 illustrates by way of example embodiment 100, a pill card 102 adapted to allow removal of doses which are to be taken for one or more days. In this case, the access tracking can be performed on a day-by-day basis. A first segment 104 is shown marked for Sunday use, with four pill compartments 106a-106d, configured for being separated from the remainder of the card, such as through the use of scoring 110. The other segments are shown similarly configured, although each segment of the card need not have the same configuration. It should be appreciated that any desired number of compartments can be provided for a given day. Compartments 106a-106d are operably coupled to electrical circuit 108 for generating communications to an external receiver, such as local devices 112 configured for communication with circuit 108, which are exemplified as watch 114, personal digital assistant 116 (e.g., any personal computing device), cellular telephone 118, and an alert device 120 such as a device made for generating alerts in response to the user falling or other medical emergencies. These devices are configured with a suitable communication interface to receive information from pill card segments that are within range.

One form of communication can comprise passive communication, such as using radio-frequency identifier devices (RFID). In the case of passive RFID, the local or body-held device periodically transmits a challenge signal whose power is received for temporarily powering circuit 108, during which it registers its data on whether pills have been accessed, and responds using the power derived from the received signal. Variations in these communications are known. In addition, it should be appreciated that numerous other communication forms are available that provide low-cost communication functions for circuit 108, which most preferably are either passive (no battery) or have an integrated low cost power source (i.e., layered poly printing process).

In performing medication monitoring functions, either separately or in combination with other functionality. It should be appreciated that communication and medication monitoring may be integrated with any existing electronic devices. For example, the pill card is particularly well suited for use with telemedical systems.

According to one implementation, the body-held or local devices 112 are configured for communicating with remote systems or personnel 122, either to communicate all data, or more preferably to communicate only when a compliance issue arises. For example, when a compliance issue arises, the local device attempts to directly communicate with the user, for example generating an alert. Failing attempts at communication, the device then generates an outgoing communication, such as through a cellular phone network, using either analog voice or IP (internet protocol), to alert other parties or a system to the situation.

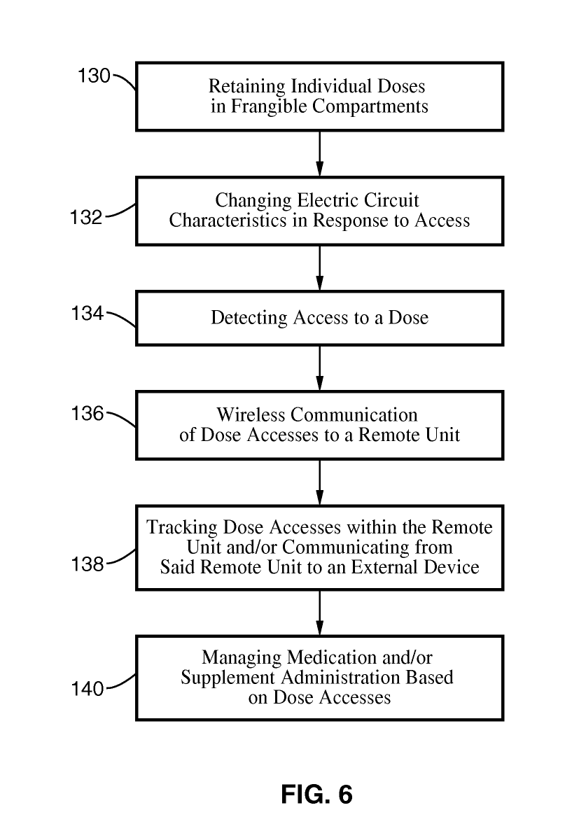

FIG. 6 illustrates, by way of example, a method according to the present invention of monitoring medicine protocol compliance using the pill card. A pill card is created for retaining individual doses within a dosing protocol as represented by block 130, wherein the doses are preferably retained within frangible compartments. In response to patient access, for example, breaking a seal or other frangible portion of the compartment, the electrical characteristics of the compartment are changed as per block 132, for example changing the conductivity of a trace or other convenient form of sensing. The change in characteristics is detected as per block 134, for example by a controller circuit and a wireless communication is initiated to a remote unit, such as the local monitoring device as previously described, as per block 136. Tracking of the dose accesses is performed in the remote unit, or the information received from the pill card can be communicated to another external device for processing as represented by block 138. Medication is thus managed at the local monitoring device and/or at an external device, as per block 140. Preferably, medicine management comprises functions such as feedback on when to take the medications, alert when medications are not time taken, statistics on compliance, alerts as to access of multiple doses, and so forth.

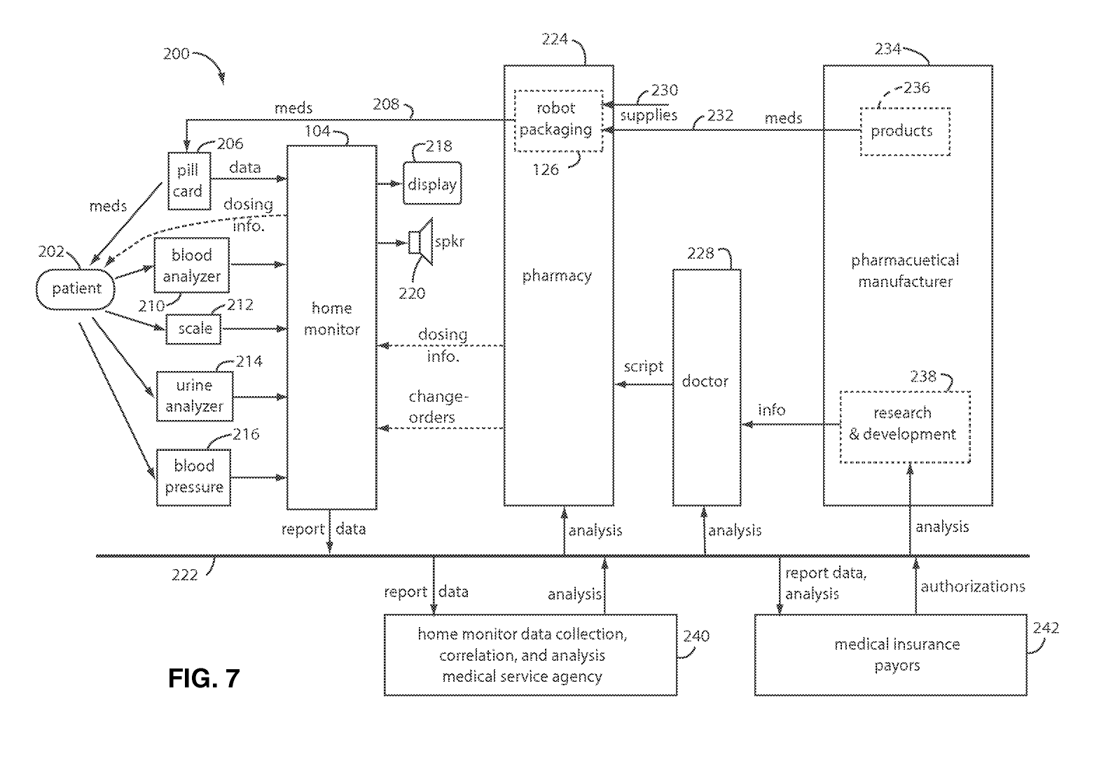

FIG. 7 shows an embodiment of the system of the present invention 200 for attending to the medical needs of a patient 202. Patient 202 has at their home a home monitor 204 that can connect with a number of specialized medical peripherals and devices. An instrumented, disposable pill card 206 with pills and other medications 208 that have been prescribed for the patient 202 is able to organize, sense, and dispense pharmaceuticals on a predefined schedule. Alternatively, the pill card includes medicines in injectible form and can comprise a single dose, and may resemble a label attached to a product more than it appears to be a product packaged in a card or box.

Pill card 206 is able to communicate the status of its medicine payloads to the home monitor 204, e.g., using wired contacts or wirelessly. For example, the communications with pill card 206 could be based on near field communications (NFC) and radio frequency identification (RFID) tag technologies.

The medications being dispensed to patient 202 can be considered an independent variable. The dependent variables are how the patient responds to the medications. Pill card 206 reports to home monitor which pills were taken, and at what time, and a variety of specialized medical peripherals collects other medical data directly. For example, a blood analyzer 210 can collect either very simple measures like oxygen uptake or more complex items like glucose, cholesterol, triglycerides, A1C1, enzyme, and so forth. A scale 212 measures the patient's body weight. A urine analyzer 214 tests for various materials, e.g., ketones. A blood pressure monitor 216 provides readings helpful for hypertension management. These and other kinds of peripherals provide data that can be sent to a display 218, transmitted through a speaker 220, reported on a communications backbone 222, or any combination thereof. The Internet, for example, is an example of a communications backbone 222.

Display 218 and speaker 220 can also be programmed to remind and inform the patient 202 which medications need to be taken and at what times, and can advise what precautions should be observed, e.g., take only at bedtime, or with food, or avoid dairy products, sun, or nitrates.

Embodiments of the present invention can help to understand and make adjustments to a patient's medications that will produce the targeted physiological effects, e.g., normal glucose, blood pressure, lipids, etc. Collecting and analyzing real time data from a large population of users can be used by doctors, insurance companies, and pharmaceutical companies to better predict dosages, their effectiveness, and to better target common pharmaceuticals.

Referring again to the embodiment shown in FIG. 7, a local pharmacy 224 may have a robotic packaging machine 226 for assembling medications 208 prescribed by a doctor 228 and then delivering them to the patient. The robotic packaging machine 226 can assemble pharmaceuticals into pill cards, and record which pharmaceuticals have been loaded into which compartments of particular pill cards and their associations with particular patients. Blister cards, vials, and other packing supplies 230 are used to package medicines 232 produced by a pharmaceutical company 234. Packing slips are electronically sent to the patient, doctor, pharmacy records, research institutes, insurance payors, pharmaceuticals, other related entities, or any combination thereof. The medications and other products 236 come from on-going research and development 238.

The doctor 228 will prescribe the medicines to take and the schedules to take them to the pharmacy 224. These instructions are relayed by the pharmacy 224 to the patient 202 in a number of possible ways, e.g., printed instructions, written to electronic memory in pill card 206, downloaded to home monitor 204 and announced through display 218 and speaker 220, etc.

Conventional tablet blister packing and medicine vials are supplemented by robotic packing 226 with sensor films and smart electronics that can detect when the patient 202 has used a particular item. These are typically implemented as flexible circuits, integrated circuit chips, and thin-films glued or laminated onto the traditional packaging.

A home monitor data collection, correlation, and analysis services agency 240 receives report data from the home monitor 204. It correlates how the dependent variables are responding to the independent variables. In this case, how weight, blood chemistry, blood pressure, and urine are responding to the medications 208 prescribed by doctor 228. The analysis can be communicated over the Internet or other applicable networks, anonymously or securely, as necessary. Medical insurance companies 242 may use the raw data, a refined analysis, or combinations thereof, to determine how their policies and authorizations should be affected.

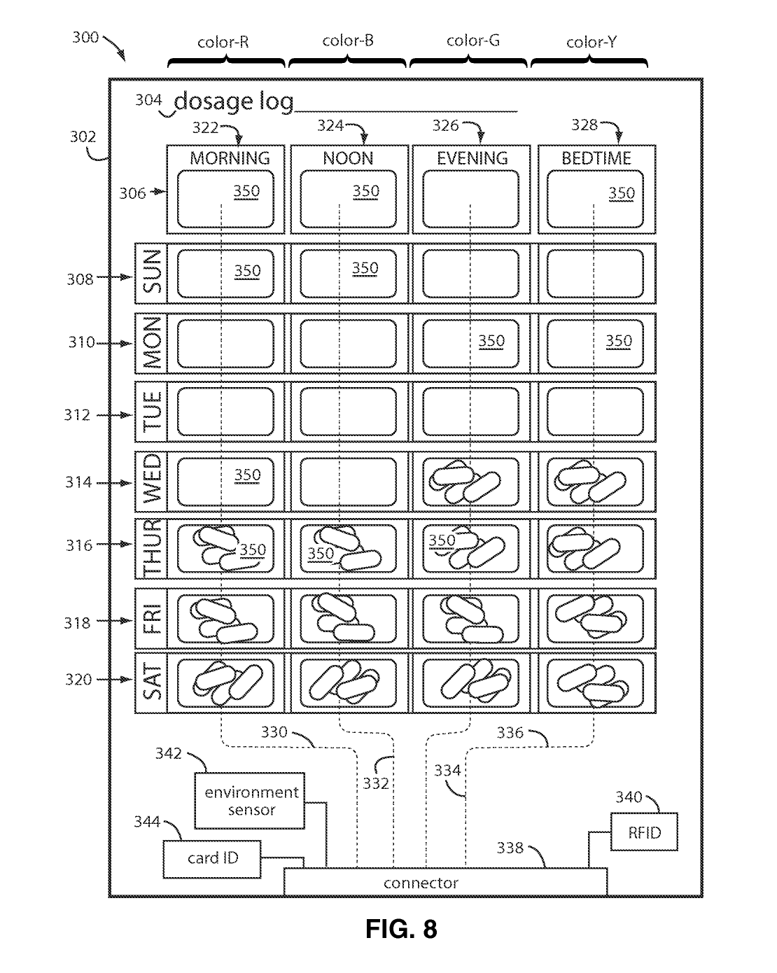

FIG. 8 represents an embodiment of a 7-day blister card 300 for the organization, scheduling, and dispensing of various kinds of pills during the course of a week, Sunday through Saturday. The system of the present invention is not limited to a 7-day card, and may be expanded to include any desired number of days. For example, a 31-day blister card could include an entire month's worth of pills, organized and scheduled, provided that there were not too many pills to make a single card impractical. This embodiment of 7-day blister card 300 will be familiar to most consumers, e.g., a cardboard backing 302 with a number of clear plastic blister bubble compartments with foil back cover.

In use, the pills are pressed from the front so the foil backs will burst and release the payload. It is then evident, even without any electronic instrumentation, how many pills are left and which bubble compartments are empty. The 7-day blister card 300 can be constructed as a cardboard disposable tray or as a reusable tray. The backing may be a metal foil, a plastic film, a paper sheet, or a combination of these elements.

A printed space 304 allows a user to make notes or keep logs with a pen in addition to automatic electronic logging. The matrix illustrated on the pill card in FIG. 8 allows for four dosing times each day of the week (labeled in row 306), but other configurations can be used to suit particular applications. Compartments are arranged in rows 308, 310, 312, 314, 316, 318, 320 and columns 322, 324, 326, 328. A number of sensor wires, represented here by 330, 332, 334, and 336, are routed in the back covering to a connector 338. The connector 338 can be plugged directly into a home monitor 204 (FIG. 7) to report which dosages have been consumed and which remain.

Alternatively, an RFID device 340 can report dosage or compartment status in response to a nearby RFID interrogation transceiver incorporated into home monitor 204. An environmental sensor 342 could be included if the medicines were sensitive to any particular environmental extremes, such as temperature, humidity, or exposure to light. Thus, the environmental sensor 342 would act as a fuse when the particular condition is experienced, to simplify the detection circuitry. A card identification (ID) 344 circuit with an encrypted serial number that was previously registered to the patient by the pharmacy, such as a common SIM chip as used in cellphones, provides positive identification of the particular card 300 and the patient 202 (FIG. 7). The card identification (ID) 344 circuit enables the recording of which pharmaceuticals have been loaded into which compartments of particular pill cards and their associations with particular patients.

FIG. 8 shows several pill compartments 350; some compartments 350 are empty, and pills remain to be taken in other compartments 350. Because the pharmacy 224 produced the blister card 300, the pharmacy 224 has a record of the original contents of each compartment 350. The pill consumption status is reported out to various monitors and readers through connector 338 and/or RFID device 340. If the blister card 300 remains within the access range of its reader (home monitor 204), the consumption can be detected and logged in real-time. Otherwise, the next time the blister card 300 is within access range, a report will be collected in batch mode. Methods and devices to enable these reports are conventional and need not be explained further here.

Graphics, legends, and colors are printed on card 302 to make it easier to identify which doses are to be taken, and at what time, with the aid of any electronics support. For example, columns 322, 324, 326, 328 can be color coded with colors R, B, G, and Y to easily distinguish them from one another. The days of the week and the time of day (morning, noon, evening, and bedtime) can be printed directly on the card 302.

A transducer may be wired to each pill compartment such that it can electronically sense when the corresponding pills have been removed. The transducer is able to communicate with a card reader if located nearby, such as within a table-top tray. The card reader may be configured like a flat tablet, and can wirelessly interrogate the transducers and announce its findings. Various communications protocols are included that are specific to patients, doctors, pharmacies, authorities, distributors, and manufacturers. A patient may want to know what pills need to be taken next and what cautions should be observed, a doctor may want to know how well the patient has complied with the prescribed regimen, and the authorities may want to know what controlled compounds are included in the card.

The following describes in detail a number of features which are supported according to different embodiments or modes of the present invention. Medication reminders can be generated to the user based on a medication protocol that is entered into the pill card, or more preferably is contained by the local monitoring device or an external management system.

The system is adapted to generate various forms of feedback, including reminders for taking medications, and reminders/alerts if a dose has not been accessed according to schedule. These reminders and alerts can be generated to the user, and/or through other personnel such as in response to a communication generated by the device directed to personnel (e.g., email, telephone) or indirectly in response to information communicated to an external system (i.e., management system at a patient care institution). Reminders and alerts can be generated as various forms of output, including: audio, lights, text/graphics, hardcopy printouts (i.e., paper), and the like.

As was shown in FIG. 1, the system can interact with the user as well as with a patient, pharmacy, doctor, caregiver, family, medical authority, or authorized third party, and combinations thereof.

One form of interaction is performed for loading the dose taking schedule into the system, for example loading it into the pill card, local monitoring device, and/or an external management system. According to one example, the pharmacy creating the pill card programs the controller with the desired dosing schedule. It will be appreciated that programming of the controller can be performed by equipment at the pharmacy, in which no additional input controls or output displays are required on the pill card itself. The schedule can be stored on the pill card, either for use by the pill card (i.e., adapted with a real time clock circuit) in generating alerts and reminders, or for being communicated to the local monitoring device or external devices which can perform desired monitoring and generation of feedback. Alternatively, the schedules can be input from a pharmacy via the internet or phone connections to either the local monitoring device or an external device. It should be noted that the schedule may be also entered directly from a user interface coupled to the local monitoring device or an external system, or less preferably from the pill card itself. It should be realized that other forms of schedule entry can be utilized without departing from the teachings of the present invention.

The embodiments of the medication distribution and monitoring system of the present invention provides for stationary or portable access to medications and supplements utilizing a low cost interactive card device without sacrificing the ability to communicate with the user or remote personnel and systems, either directly or through an intermediary link.

Another advantage area for this technology is that it can provide a crucial link between patient and pharmacy, or other party filling the associated scripts, wherein the instructions for taking the medications are encoded electronically in the inexpensive disposable card device. This information can be encoded and utilized in different ways according to the invention.

A method for controlling doses of medicines for patients at home includes packaging medicines into a container that is able to automatically report when a patient actually consumes a particular dose. Then the container is monitored for evidence the patient has taken a dose of medicines. Physiological data is collected at home from the patient during the time frame the patient is taking doses of medicines from the container. The apparent physiological effects on said patient that the medicines are having, given the dosage schedules that are actually being observed, are correlated and analyzed. The dosage schedules and medicines are adjusted in view of the analysis to arrive at target values for the physiological data as determined by a doctor.

From the foregoing examples, it is clear that the system of the present invention can be utilized in various ways. The following scenarios are presented as non-limiting examples of systems contemplated in the present invention.

### EXAMPLE 1

The medication card is a smart card that can store data. The pharmacy programs the card with dosage information and provides the medication card to the patient. The medication card can communicate with the home monitor, and the home monitor can keep track of when and how often medications are taken.

### EXAMPLE 2

The medication card is a smart card that additionally contains a security device, such as an RFID chip. The pharmacy provides the medication card to the patient with no programming. The dosage information is provided by the pharmacy to the home monitor. When the patient links the medication card with the home monitor, the monitor identifies the card and matches the appropriate prescription information with the card.

### EXAMPLE 3

The medication card is not a smart card, and is provided to the patient. The pharmacy sends prescription information to the home monitor. The patient is then responsible for following the prescription and reporting relevant information to the home monitor.

In any scenario, the home monitor can communicate and exchange information with other entities, such as pharmacies, doctors, or medication monitoring agencies.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for monitoring medication utilization, comprising:
a plurality of frangible compartments, each compartment configured for retaining an individual dose of medications and/or supplements;
means for sensing when frangible access is made to any of said plurality of frangible compartments; and
means for wirelessly communicating said frangible access to an external receiver adapted for medication management.

2. An apparatus as recited in claim 1, wherein said means for sensing frangible access comprises at least one conductive element coupled to a given frangible compartment and configured to change conductivity in response to accessing a dose from the given frangible compartment.

3. An apparatus as recited in claim 2, wherein said means for sensing frangible access comprises at least one conductive pathway whose conductivity is changed in response to accessing a dose from the given frangible compartment.

4. An apparatus as recited in claim 1, wherein said means for wirelessly communicating comprises a radio-frequency transmission device configured for communicating information about frangible access being made to the medications and/or supplements contained in said frangible compartments.

5. An apparatus for monitoring medication utilization, comprising:
a plurality of frangible compartments, each compartment configured for retaining an individual dose of medications or supplements;
a sensing element coupled to each of said plurality of frangible compartments and configured for sensing when frangible access is made to any of said plurality of frangible compartments; and
a transmitter element configured for wirelessly communicating said frangible access to an external receiver adapted for medication management.

6. An apparatus as recited in claim 5, wherein said sensing element comprises at least one conductive pathway whose conductivity is changed in response to accessing a dose from the given frangible compartment.

7. An apparatus as recited in claim 6, wherein said conductive pathway is severed in response to accessing a dose from the given frangible compartment.

8. An apparatus as recited in claim 7, wherein said conductive pathway is disposed upon a frangible membrane which seals each said compartment to form a frangible compartment.

9. A method of tracking medication administration, comprising:
retaining a plurality of individual doses within frangible compartments for access by a user;
changing an electrical circuit configuration in response to breaking the frangible seal on any of said individual doses;
detecting access to a dose in response to receiving said change in electrical circuit configuration;
communicating to a remote unit in response to the detected access;
wherein said communicating is over a wireless communication medium; and
wherein said remote unit is configured for tracking dose accesses, or for communicating to an external device over a wired or wireless communication medium, or a combination of tracking dose accesses and external device communication.

10. A system for controlling medications taken by a patient, comprising:
a pill card with individual compartments filled with medications for a patient, and including sensors to detect which medications have been dispensed, and including devices to report a pill payload status;
a number of specialized medical device peripherals arrayed to collect physiological data about said patient in periodic tests;
a home monitor for reading said pill payload status from the pill card, and for collecting data obtained by said number of specialized medical device peripherals; and
a data collection, correlation, and analysis process able to receive data collected from the home monitor, and for providing an analysis of the effectiveness of said medications as judged by the patient's adherence to dosage schedules and the responses observable in said physiological data.

11. A system as recited in claim 10, wherein the pill card includes medicines in injectible form and can comprise a single dose.

12. A system as recited in claim 10, wherein the pill card includes medicines in pill form, and uses blister packaging wherein the rupturing of a back covering causes said sensors to operate.

13. A system as recited in claim 10, further comprising:
a packaging robot for location at a pharmacy that can assemble pharmaceuticals into the pill card, and that further records which pharmaceuticals have been loaded into which compartments of particular pill cards and their associations with particular patients.

14. A system as recited in claim 10, further comprising:
a card identification device to enable the recording of which pharmaceuticals have been loaded into which compartments of particular pill cards and their associations with particular patients.

15. A system as recited in claim 10, further comprising:
a speaker connected to the home monitor for announcing dosage schedules and cautions to the patient.

16. A system as recited in claim 10, further comprising:
a display connected to the home monitor for showing dosage schedules and cautions to the patient.

17. A method for controlling doses of medicines for patients at home, comprising:
packaging medicines into a container that is able to automatically report when a patient actually consumes a particular dose;
monitoring said container for evidence said patient has taken a dose of said medicines;
collecting physiological data from said patient during the time frame the patient is taking doses of said medicines from said container;
correlating and analyzing the apparent physiological effects on said patient that said medicines are having given the dosage schedules that are actually being observed; and
adjusting said dosage schedules and medicines to arrive at target values for said physiological data as determined by a doctor.

18. A method as recited in claim 17, further comprising:
announcing to said patient certain doses are due to be taken.

19. A method as recited in claim 17, further comprising:
announcing to said patient cautions associated with taking certain doses due to be taken.
